(19) United States
(12) Patent Application Publication
(10) Pub. No.: US 2025/0042128 A1
(43) Pub. Date: Feb. 6, 2025

(54) CELLULOSE PRECURSOR MATERIAL AND APPARATUS AND METHOD FOR FIELD CONVERSION OF THE PRECURSOR INTO CELLULOSE INSULATION

(71) Applicant: CleanFiber Inc., Blasdell, NY (US)

(72) Inventors: Jonathan Strimling, Bedford, NH (US); Randell Drane, Winchester, MA (US); Michael Bilodeau, Clermont, FL (US); Nicholas Yardy, Portland, ME (US); Marco L'Italien, Enfield, ME (US)

(73) Assignee: CleanFiber Inc., Blasdell, NY (US)

(21) Appl. No.: 18/717,399

(22) PCT Filed: Dec. 7, 2022
(86) PCT No.: PCT/US2022/052187

§ 371 Date: Jun. 6, 2024

Related U.S. Application Data
(60) Provisional application No. 63/287,045, filed on Dec. 7, 2021.
(60) Provisional application No. 63/303,423, filed on Jan. 26, 2022.

(51) Int. Cl. B32B 5/26; B32B 5/04

(52) U.S. Cl. CPC B32B 5/26; B32B 5/04; B32B 2250/20; B32B 2260/023; B32B 2262/062; B32B 2307/3065; B32B 2307/746

(57) ABSTRACT

A cellulose precursor material for making cellulose-based products including cellulose insulation. The cellulose precursor material for insulation includes a plurality of fibers, wherein at least a portion of the plurality of fibers are cellulose fibers and a binder that joins the fibers together while the precursor material is transported while also allowing at least a portion of the plurality of fibers to be separated from each other to form cellulose insulation. The cellulose insulation may be made at a remote location and the use of the precursor material reduces insulation transportation costs. An apparatus and method for making the insulation from the precursor material are disclosed. An apparatus and method for making the precursor material are also disclosed.

### BACKGROUND OF THE INVENTION

### 1. Field of the Invention

The present invention relates to the cellulose insulation. More particularly, the present invention relates to a cellulose-based precursor material that may be processed in the field to form a cellulose insulation. The present invention further relates to an apparatus to process the precursor material on site into an insulation product that may be blown into place and methods for doing the same.

### 2. Description of the Prior Art

Existing cellulose insulation is shredded, treated, fiberized, and packaged in a central plant. Bags containing the processed and packaged cellulose insulation are then distributed to users who open the bag, add the contents to an installation machine, such as a blower arranged to re-aerate cellulose fibers that may have been compressed in the packaging process, and blowing them into their installed positions. The existing process for making and packaging the cellulose insulation can be expensive. In addition, the re-aeration and installation of the insulation fibers can be time consuming and labor intensive. What is needed is a more cost-effective system and method for producing cellulose insulation that can be shipped in a compressed form and expanded at a remote location, such as at the location of installation, distribution, or at a downstream manufacturing plant such as where prefabricated structures may be assembled. What is also needed is a cellulose-based precursor product in sheet or roll form that can be transported to a remote site and processed by a machine to achieve a desired bulk density and installed on site.

### SUMMARY OF THE INVENTION

The present invention is a cellulose-based precursor material and an apparatus and method for processing that precursor material in the field to complete formation of a cellulose insulation material from the precursor material and install it on site.

The precursor product in readily transportable form, such as in sheets or rolls but not limited thereto, can be used to make cellulose insulation on site where that insulation is installed. The precursor material may also be converted to an expanded or lower density structure offsite and formed into sheets or rolls that are delivered to a remote site. For example, a compacted material shipped from a manufacturer may be expanded at a distributor's site prior to shipment of the expanded product to an end-use site. The precursor material is any cellulose material previously formed into a cellulose-based precursor, which may be produced in the form of solid paper, tissue paper, a porous web, mats, etc. and may be delivered in sheets, fan folds, rolls, webs, mats, or other forms. Fibers of the precursor material may be joined together with a binder. The joining may be a loose joining to enable density reduction of the precursor material relatively easily by using the apparatus of the present invention at a location of interest. The binding material may be water but not limited thereto.

The precursor material may include expansible elements such as expansible microbeads. The microbeads may be expanded to increase the bulk of the precursor material, at the point of manufacturing, prior to delivery to the installation site (such as by a distributor), or they may be expanded at the installation site (whether at a construction site or at the location of manufacturing of a prefabricated assembly). The cellulose-based precursor material product may or may not be treated with one or more components of interest including, but not limited to a fire retardant material either prior to delivery to an installation site, at an intermediate site (such as a distributor) or after delivery to the end-use site.

The precursor material is provided in a condition to enable its conversion into cellulose insulation while in the field or alternatively the precursor material may be provided in a condition to enable its conversion into a component of a cellulose insulation at a remote location. That condition may be a compacted form of cellulose material, such as paper (including folded paper) as well as mats of compressed fibers. This minimizes the delivery costs, which otherwise could be higher if they were associated with transport of finished, lightweight, cellulose insulation. The precursor material may be generated in deliverable condition having a density and structure appropriate for producing a desired R-value and fire resistance of the cellulose insulation formed. The precursor product may be modified at an intermediate site (such as a distributor) or at the end use site to reduce its bulk density, such as by shredding and/or aerating it. The precursor material so modified (after expansion and aeration) may be referred to herein as precursor-derived cellulose insulation. The precursor-derived cellulose insulation may be a matrix of fibers including cellulose fibers with a bulk density in the range of about 1 to about 5 pounds per cubic foot, with a critical radiant flux of greater than 0.12 W/cm², and a smoldering combustion rate of <15% per American Society of Testing and Materials (ASTM) test C739.

The precursor material is formed of fibers that are recycled fibers, virgin fibers, or a combination of the two. The precursor material is prepared offsite prior to delivery to a remote site for further processing including, but not limited to, shredding and aeration. The precursor material may be modified in part rather than completely prior to delivery to the installation site. The precursor material may be treated with a fire retardant prior to installation and/or fire retardant materials may be added to the precursor during conversion to precursor-derived cellulose insulation. The precursor material may include a fire retardant that has been integrated with the fibers used to make the precursor material prior to forming it into the precursor material, a fire retardant that has been applied to the precursor material after forming, or a combination of the two. For example, the application of fire retardants to the fibers in the wet end of a paper-forming process may impact the fire resistance and mechanical properties of the precursor material differently than if that fire retardant or a different chemistry is applied via a sizing process after the cellulose-based precursor material has been formed. The application of the fire retardant materials may therefore be tuned in a way that is most advantageous for the precursor material.

The precursor material may have a porosity of 10% or more by volume. That porosity may be established using an expanded or expandable component, such as a foaming agent or microbeads. That porosity may be established in the forming process, such as through through-air-drying. The precursor material may also include one or more of debonding agents, odorants, and deodorants. Further, reactive zeolites may be integrated into the precursor material to reduce odor and/or to capture or react with one or more Volatile Organic Compounds (VOCs). The precursor material may be provided in rolls for ease of unwinding or in accordion folded sheet form that can be fed into automated processing equipment. The precursor material may be provided in stacked sheets that are not joined together, and which may be fed manually into a machine and/or may be fed by an automated sheet feeder (such as is the case for paper in a copying machine, but at a larger scale). The precursor made be fed into the machine in sheet form or the machine may have blades that advance into the precursor material or other means to consume the precursor material and to feed it into the aeration machine. It is not limited to those configurations.

As noted, a portion of the process for converting the precursor material may occur at the installation site. For example, the precursor material may be processed at a remote site to expand its volume by aeration. Alternatively, or in addition to aeration, the precursor material may be expanded in sheet form. The precursor base material is treated with a fire retardant. The fire retardant may be applied via roll-to-roll processing by infusing a fire retardant material such as a liquid borate, for example, via a sizing press. The fire retardant may also or alternatively be applied by pressing dry-powder fire retardant onto a dry or moist precursor material surface. That is, the base cellulose material can be treated with both liquid and powder fire retardant composition after sizing when partially and/or fully dried. The fire retardant may be selectively applied at any time in processing the precursor material including, but not limited to, when substantially in insulation form.

The precursor base material may be made porous with a resultant reduced density prior to aeration by infusing therein an expansion component, such as microbeads or a foaming agent, for example, via application at the wet end of paper manufacturing or via addition of one or more such additives to the material using a sizing press. Alternatively, the base material may be made porous by infusing the expansion component via a dry application and/or with a forced airflow through base paper that is already porous, thereby trapping the expansion component in the precursor matrix, which acts as a filter to collect the expansion components.

The cellulose-based precursor material may be supplied suitable for forklift interactions and operator interactions. A specific example of a suitable cellulose-based precursor material starter component is a 4 ft by 4 ft stack of fanfold paper 6 ft high on a skid or slip sheet for forklift interaction and with a pull tab on the top sheet to aid in operator initialization of the paper feeding to a precursor processing machine located on site. Sheets or mats of the precursor material may be perforated, scored or otherwise prepared to be disassembled rapidly by an aeration machine.

The apparatus and related method may be used in the field for conversion of the precursor material into cellulose insulation and, optionally, for installation of that insulation in a location of interest. The apparatus includes one or more components configured to receive and convert the precursor material into insulation ready for installation. The apparatus is configured to enable conversion of the precursor material into cellulose insulation while in the field, rather than at a factory, which may be far away from the installation site. This reduces costs associated with insulation material transport. The use of an aeration machine at a remote site may also enable the delivery of a lower density material to the ultimate location of use, such as an installation location. The apparatus includes field conversion equipment arranged to receive the precursor material, such as paper-based precursor materials including fire resistant paper-based precursor materials, and optionally may include equipment to reduce the size of that starter material. The received precursor material is then modified to reduce its bulk density, such as by aerating it. The reduced density precursor material may optionally come in different configurations. The apparatus is optionally configured to receive the precursor material in different forms, such as the paper-based precursor material in compacted, web, mat or other form. Multiple versions of the precursor material may be mixed together and then that mixture reduced in density, such as by aeration. Additionally, a precursor material may be mixed with conventional loose fill cellulose insulation before or after aeration to achieve the targeted physical and thermal properties. The apparatus may be further configured to produce on site a matrix of fibers including cellulose fibers with a density in the range of about 1 to about 5 lbs./cu ft., with a critical radiant flux of greater than 0.12 W/cm², and a smoldering combustion rate of <15% per American Society of Testing and Materials (ASTM) test C739.

The apparatus further optionally includes component features and/or coupling to components that are used to deliver the fabricated cellulose insulation from a field aeration location to an insulation installation location. In one aspect of the invention, the apparatus is configured to provide a mechanism for blowing the cellulose insulation in place by forcing the insulation in an airstream to the location. That propulsion mechanism may include pressure monitoring to ensure regulation of insulation material delivery and detection of clogging that may occur.

The apparatus also optionally includes one or more delivery devices for the application of one or more additives of interest to the materials in process prior to or during installation. The additives include but are not limited to: a) one or more odorants and/or deodorants; b) one or more dust controllers such as mineral oil; c) one or more mold growth and/or rodent infestation deterrents, such as one or more borates; and d) one or more fire retardancy materials, such as borates or sulfates. The one or more additions may be added by selectable metering, regulation and/or sensing to the composition of the precursor material before, during, and/or after one or more of the density reduction options.

The apparatus may further be configured to provide for moisture regulation of the cellulose insulation before, during, and/or after delivery to the remote site. For example, and not limited thereto, the apparatus optionally includes a moisture delivery component such as a material dampening sprayer that is configured to add moisture in the form of water or other liquid to the cellulosic precursor material before, during, or after density reduction. The dampening sprayer is optionally a hose coupled to a moisture supply and that includes one or more exit ports that each may include a spray nozzle. The exit ports may be located at any one or more of the entry to the hose used to blow the cellulose insulation in place, at an intermediate location between the insulation delivery hose entry and exit, and/or after the insulation delivery hose exit. Addition of moisture after the insulation material delivery hose exit minimizes the chance that the cellulose insulation will clump and clog the hose before exiting.

The apparatus includes one or more fiber separation components for reducing the density of the precursor material to convert the precursor material into a cellulose insulation product. The fiber separation components may be one or more of an impeller used to transport and separate cellulose fibers; a carding device that can finely separate fibers prior to blowing; and a mill that finely separates fibers through rotating and/or opposing milling plates, a chopper or intensifier having rapidly moving blades, for example, or other means to finely separate fibers prior to installation. The component or components chosen for fiber separation may be dependent upon the characteristics of the precursor material used. For example, compressed cellulose mats of precursor material may be separated using an impeller whereas a looser packing of the cellulose precursor material may only require the use of an aeration component, such as a blower.

The apparatus may also optionally include one or more isolation systems that are arranged to isolate sections of the production and installation delivery phases of operations. For example, the apparatus may include one or more airlocks arranged to separate precursor material modification operations from insulation material delivery operations, such as a blower that is coupled to the insulation delivery hose. This can allow the insulation delivery hose to operate at positive pressure without an excess of backwards airflow towards the precursor modification processes. In addition, the apparatus may optionally include one or more monitors and controllers to monitor and control the precursor modification and insulation delivery operations. One or more monitors may be deployed throughout the apparatus operations including for monitoring the status of supplies, monitoring precursor density reduction status; monitoring additive delivery status; monitoring conveyance operations for any clogging or supply backup; and monitoring production and delivery rates to detect any delay or acceleration deviations. The monitors may be analog or digital. As one example, a weight scale may be one type of monitor that is used to detect the quantity of the precursor supply material that is available for transfer to the density reduction stage and/or other material modification stages. Air pressures may also be monitored to prevent clogging and other malfunctions.

The one or more controllers may be coupled to the one or more monitors and to controllers that are local or remote. The controllers are arranged to address sensing that supply material, including any additives of interest, are running low and either halt fiber processing or signal for the introduction of replacement supply. The controllers are further arranged to slow or accelerate one or more stages of the production and delivery process. For example, at the installation end of the system there may be sensed the need to deliver more cellulose insulation. The controller is arranged to accelerate one or more of fiber insulation production and blower rate for faster insulation transport. The one or more controllers are also arranged to respond to any sensed clogging of the system, such as by detecting increased or decreased movement caused by any one or more of: a) stopping or slowing precursor modification; b) stopping or slowing insulation feed to the delivery hose; c) maintain or increase line pressure with no fiber feed until clog clear is confirmed by monitoring; and d) adjusting fiber flow rate at one or more of fiber processing and insulation delivery until line pressure is within a selectable range.

In an example embodiment of the invention, the apparatus is configured to accept appropriate widths of specifically and intentionally designed precursor material sheets, batts, or mats, for example, that are appropriately metered, aerated and distributed to a location of interest, such as an insulation installation site. The precursor material may be appropriately treated with fire retardants and other materials to aid the aeration, R factor, distribution, longevity, pest resistance, air permeability and possibly other characteristics of the insulation end product. As an example, borates may be used for fire retardancy, mineral oil may be used for dust control, and essential oils may be used for odor control. The precursor material used may be packaged to facilitate handling by an operator. The operator may be a robotic operator. The precursor material may be delivered in the form of rolls, pallets, stacked sheets or fan folds. The precursor material may be supplied suitable for forklift interactions and operator interactions. A specific example of a suitable precursor material starter is a 4 ft by 4 ft stack of fanfold paper 6 ft high on a slip sheet for forklift interaction and with a pull tab on the top sheet to aid in operator initialization of precursor material feeding to the precursor material processing equipment of the apparatus.

In this example, the precursor-accepting machine is configured to feed the precursor material into the machine in a metered way such that aeration, possible fiberization, other processing activities of interest, and/or conveying rates can be controlled. The metered precursor material in a relatively compacted form, such as a mat, batt, or web, is separated, such as by aeration but not limited thereto. The aeration may be accomplished with a shredder, blower, and/or other means. The precursor material may also optionally be shredded by one or more of spinning blades, pins, chains, and possibly other means to create a homogeneous, fine sized, possibly individual fiber level distribution of paper fibers and mixed with air during or after the shredding. Two separate processing paths may be employed to create two different fiber size distributions, which may aid in achieving targeted performance characteristics. Additional treatments of the loosened fibers of the precursor material may also be added before or after aeration to facilitate dust control, bulkiness, cohesiveness, flowability, and installed stability over time. As an example, mineral oil may be applied for dust control.

The aerated insulation is then conveyed in a controlled way, such as with a rotating airlock, into or onto a conveying means. One such conveying means would be flowing air in a tube or hose. The conveyor optionally includes a speed controller. For instance, with air conveyance, air flow rate can be controlled. The precursor-material-accepting machine may include remote controlled features such that an operator can control precursor metering, fiber aeration, insulation feed, air flow, and other parameters from a remote location. Said remote controls might be wireless or with hard wired communication. Said controls may also include artificial intelligence aspects that can learn operator, product, and machinery needs and respond accordingly and faster than a human operator. The precursor-accepting machine also optionally includes one or more monitors to provide feedback on system performance. For instance, current meters for motor performance and pressure meters for knowing conveying status may be coupled to the apparatus. A particular option includes a sensor for how much precursor material feed remains in the current supply, and/or a camera that allows visual confirmation of many aspects of the precursor-accepting machine's operation.

The precursor-accepting machine optionally includes error handling aspects such as jam control, operator presence or absence, imminent conveyor plugging, plug clearing, and apparatus reset. Said error handling means might have communication means with the operator. The communication means may be wireless screen notifications, horns or flashing lights.

The apparatus and related method of the present invention enable the production of insulation with precursor material to be shipped in a much more compressed state of rolls, stacks of fanfold, or loosely joined web rather than the end-product low density loose fiber insulation that is simply blown into place. Fire retardant materials may be added during the production of the precursor material. The precursor material may be specifically designed such that upon field aeration, the finished insulation meets specific performance characteristics for density, R-value, flame spread, smolder, fungus resistance, and/or other relevant performance characteristics. The precursor material is aerated at a remote location such as at an installation site or a distribution site, and dust mitigation and/or odor treatments may also be applied at that remote location. Aeration may expand the product by a factor of about 2× to about 10×. Moisture control can be maintained in the field to create a stabilized product, meaning a product where the fibers adhere to each other via bonding as the moisture evaporates.

The invention also includes a method for making a cellulose precursor material. Primary step of the method include directing a plurality of loose cellulose fibers having a first bulk density to an apparatus configured to convert the loose cellulose fibers into the cellulose precursor material, and organizing, aligning, and assembling the loose cellulose fibers into a mat, batt, sheet, board, or web of the cellulose precursor material, wherein a bulk density of the cellulose precursor material is greater than a bulk density of the loose cellulose fibers. The method also includes the optional step of compressing the mat, batt, sheet, board, or web to a bulk density greater than 9 lbs./ft3. The compressing may be accomplished by rollers, platens, or under vacuum assisted compression. The method optionally includes the steps of separating at least a portion of the fibers of the cellulose precursor material and reassembling the separated at least a portion of the fibers. The loose fibers may be size sorted prior to the step of organizing, aligning, and assembling. The step of organizing, aligning, and assembling optionally includes the step of air-laying the loose fibers into the mat, batt, sheet, board, or web. A binder may be added to the cellulose precursor material. The binder may be applied by spraying, dip-coating, curtain coating, or impregnating the binder on the mat, batt, sheet, board, or web. Optionally, the loose fibers may be sprayed, infused, or saturated with binder prior to the step of organizing, aligning, and assembling. Optionally, the method includes the step of vacuum packaging, fanfolding, or rolling the assembled cellulose precursor material.

The treatment for fire retardancy can be accomplished during manufacture of the precursor material and using roll-to-roll treatment processes. Particular attention must be paid to the issues of fire retardancy and embrittlement in the production of a suitable paper-based precursor material. While many fire retardants may provide sufficient fire resistance, most (including borates) will typically embrittle a paper-based material, making it inappropriate as a precursor material because it will not be sufficiently low in density after aeration in the field. This apparatus and method involve carefully engineered upstream processes to produce precursor materials that are suitable for aeration in the field, meeting strict post-aeration requirements for density, flame spread, smolder resistance, mold growth, and related commercial performance requirements. The result is a cost effective in-the-field manufacturing and installation process that makes the material shipment process much more compact. In the field, the aeration of the fibers can be more efficient from a distribution perspective and less damaging to the fibers in aggregate than the conventional methods of production and distribution of cellulose insulation, which include shredding, fiberizing, compacting, and then attempting to reaerate via blowers at a remote manufacturing location.

What is needed is a precursor material, an apparatus, and a method configured to reduce the cost of transporting loose insulation while ensuring the installation of a high-quality, regulation compliant, cellulose insulation product to a location of interest.

### BRIEF DESCRIPTION OF THE DRAWINGS

FIG. 1 is a simplified side view of the on-site cellulose insulation production and installation apparatus of the present invention.

FIG. 2 is a simplified side view of the apparatus of the present invention with the precursor in accordion form as the starter material.

FIG. 3 is a simplified side view of the system of the present invention with the precursor material in folded form as the starter material.

FIG. 4 is a simplified cross sectional side view of the precursor material prior to processing to form the precursor-derived cellulose insulation.

FIG. 5 is a simplified cross sectional side view of the precursor-derived cellulose insulation formed with the precursor material after processing in the apparatus of the present invention.

FIG. 6 is a simplified cross sectional representation of an embodiment of the precursor material before and after expansion.

FIG. 7 is a simplified representation of one mechanism for expanding an embodiment of the precursor material including microbeads as an agent to expand the precursor material.

FIG. 8 is a simplified flow diagram showing primary steps of the method of the present invention for converting precursor material into an insulation product.

FIG. 9 is a simplified side view of primary components of a first apparatus for making the cellulose precursor material.

FIG. 10 is a simplified side view of primary components of a second apparatus for making the cellulose precursor material.

### DETAILED DESCRIPTION OF THE INVENTION

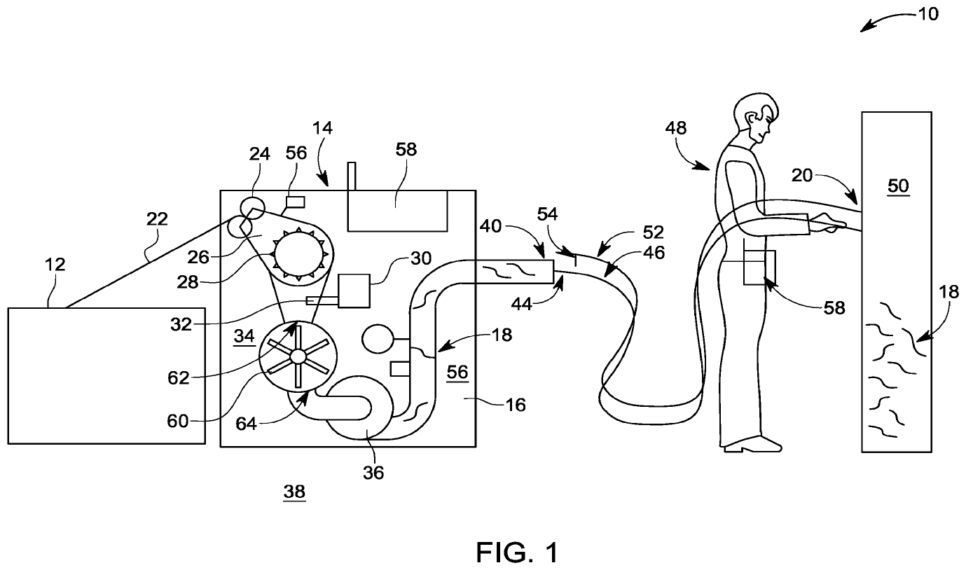

An on-site cellulose insulation production and installation apparatus 10 of the present invention is shown in FIG. 1. The apparatus 10 includes a cellulose precursor material supply 12, a precursor material processing machine 14, and an insulation installation delivery component 16. The machine 14 and the delivery component 16 are arranged and coupled together to enable the production of cellulose insulation 18 and the delivery of that insulation 18 to an installation site 20, all while in the field.

The supply 12 may be a container, pallet, or other apparatus for retaining thereon or therein one or more precursor materials 22 for making the insulation 18. The one or more precursor materials 22 will be described in more detail herein. The precursor material 22 is conveyed by transfer component 24 into inlet 26 of the machine 14. The transfer component 24 may be a conveyor belt or band, or other type of material transport device arranged to move the precursor material 22. It may be a roller set, for example, but not limited thereto. A plurality of transfer components 24 may be used to deliver the precursor material 22 to fiber aeration machine 28.

The fiber aeration machine 28 is arranged to convert the precursor material 22 into a composition of fibers that has a lower bulk density than that of the precursor material 22. The fiber aeration machine 28 may optionally include a shredder, an impeller (such as is used in blowers and fans), a chopper or intensifier (such as a rapidly rotating blade) or a fiberizer (such as a dry milling process) to shred the precursor material 22 if needed or desired. The fiber aeration machine 28 does include an aerator or other type of fiber aeration mechanism as described herein. Multiple stages of aeration and possible separation may be used. The fiber aeration machine 28 shown represents one or more components that may be used to aerate the precursor material 22, and optionally to separate fibers prior to aeration, reducing the bulk density of the precursor material 22 to produce the insulation material 18. One or more additives may be applied to the precursor material 22, the insulation material 18 in entering or exiting the fiber aeration machine 28 or both. The one or more additives may be supplied from additive supplier 30, which represents one or more additive supply containers. The additive supplier 30 may include one or more outlets 32 for delivery of the one or more additives as described herein. Output 34 of the fiber aeration machine 28 is coupled to insulation material delivery component 36.

The insulation material delivery component 36 may optionally be used to transfer the produced insulation material 18 for installation. Alternatively, the insulation material 18 may be stored or otherwise used. When the insulation material 18 goes directly to installation, the insulation delivery component 36 may be a blower configured to draw into inlet 38 the insulation material 18 from the fiber aeration machine 28 and transfer it to outlet 40. The delivery component 36 represents one or more such devices that may all be blowers or may be different types of material transfer components. The delivery component 36 may be arranged to fluff or otherwise reduce the bulk density of the insulation material 18 as it moves to the installation site 20 through insulation material delivery hose 46. The delivery hose 46 may be ribbed to assist in separating and aerating fibers as they travel through the delivery hose 46.

Outlet 40 of the delivery component 36 is coupled directly or indirectly to inlet 44 of the insulation material delivery hose 46. The delivery component 36 may be configured to enable movement of the insulation material 18 therefrom through the delivery hose 46 with sufficient pressure to enable an operator 48 to direct the insulation material 18 into the installation site 20 to fill cavity 50 as desired to generate insulative characteristics of interest at the installation site

The apparatus 10 optionally includes moisture delivery hose 52, which may include one or more ports 54 arranged to deliver a fluid of interest, such as water, to the insulation material 18 at the beginning, intermediate, and/or end of the delivery hose 46. The moisture delivery hose 52 may also be configured to deliver moisture to the insulation material 18 at other points through the machine 14. The apparatus 10 further optionally includes one or more monitors 56 positioned to monitor the condition of any one or more of the precursor material 22, the insulation material 18, the delivery hose 46, the fiber aeration machine 28, and the transfer component 24. The apparatus 10 also optionally includes one or more controllers 58 arranged to enable regulation of the components of the machine 14. The controllers 58 may include a remote controller, a controller coupled to the machine 14, and a controller managed by the operator 48.

The apparatus 10 optionally includes airlock 60 positioned between the fiber aeration machine 28 and the delivery component 36. The airlock 60 includes an inlet 62 coupled to output 34 of the fiber aeration machine 28, and an outlet 64 coupled to inlet 42 of the delivery component 36. The optional airlock 60 is configured to minimize feedback of insulation material 18 into the fiber aeration machine 28.

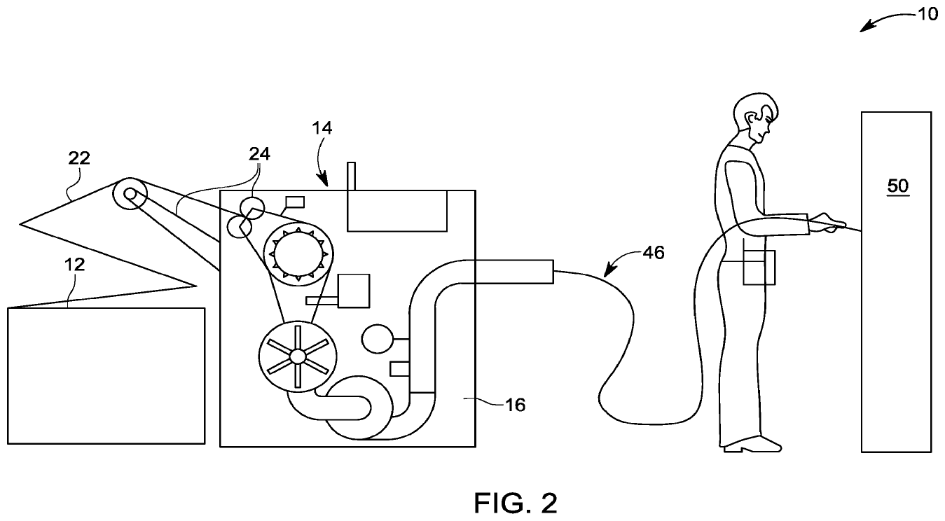

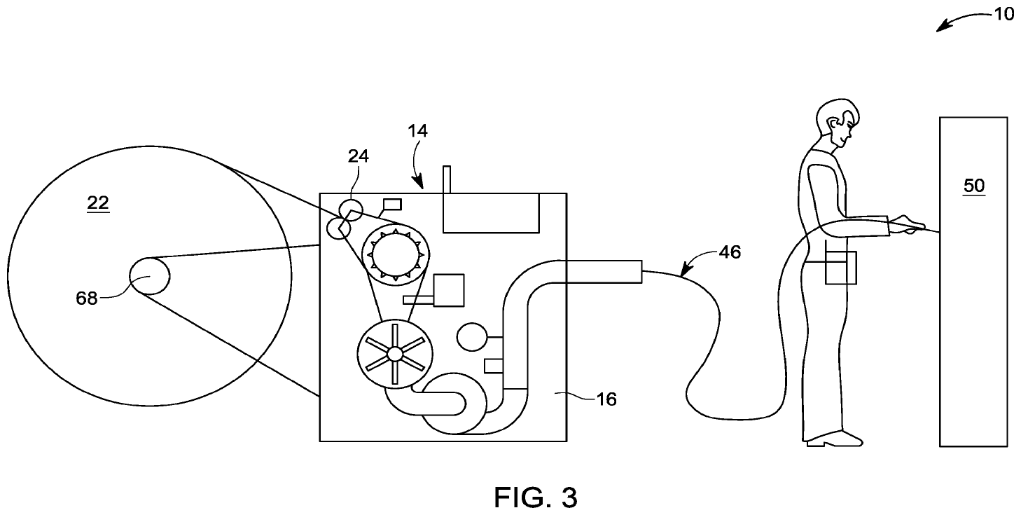

Optional mechanisms for conveying the precursor material 22 to the machine 14 are represented in FIGS. 2 and 3. As shown in FIG. 2, the precursor material 22 is in accordion form. The precursor material 22 is joined to transfer component 24, which may be a roller set. As shown in FIG. 3, the precursor material 22 is in roll form. The precursor material 22 is located on core 60 and joined to the transfer component 24 for delivery to the fiber aeration machine 28. For paper-based precursor materials as the precursor material 22, the fiber aeration machine 28 may include a shredding component to chop the paper into pieces that are converted into fiber components.

An advantage of the present invention is the labor reduction resulting from use of the components of the apparatus 10 as described. The components of the apparatus 10 are sized sufficiently to enable their operation in the field, although they may also be used for cellulose insulation production and transport to a remote location using an alternative delivery mechanism. A further consideration in the enablement of in situ production and installation is the form of the precursor material 22. When the precursor material 22 is in a sheet form, the precursor material 22 may be supplied in a specific way and configuration that reduces labor requirements. For example, there may be two or more sheet stacks on each skid. Each stack may be 2′ wide (easier to manage) and 4′ deep×4′ tall. A string or sheet of one stack may be affixed to the bottom of another stack that is above the first stack. Additionally, the transfer component 24 may represent a plurality of transfer components, with each individual transfer component joined to a skid having the two or more stacks. In that way, one transfer component can always be running while the transfer component of an empty skid could be resupplied with a new skid full of stacks. That way, if there any issues with feed on one side, or at the end of a skid, it automatically changes over.

The example arrangement described above for the stacks is suitable when the paper is in accordion form as shown in FIG. 2. For the stacks, the sheets may be lightly joined or affixed together to prevent unwanted separation prior to or during transfer to the fiber aeration machine 28 and may eliminate the need for wrapping of the stack during transport. For example, layers may be lightly bonded together with an adhesive in some locations. The layers may be perforated or scored to keep them together until pulled apart and into the fiber aeration machine 28 by transport component 24. The sides of the sheets could be punched or dimpled to enable that securing without impeding the transport to the fiber aeration machine 28.

The precursor material 22 includes a base of a plurality of fibers that are recycled fibers, virgin fibers, or a combination of the two. The source of the fibers is selectable and may include but not be limited to paper, OCC, and other cellulose fiber sources. The precursor material 22 may be treated with one or more additives including, but not limited to, fire retardant materials, adherents, debonding agents, odorants, deodorants, and one or more material expanders. The fibers and any additives are pressed or otherwise compacted into sheet or roll form for ease of transport, ease of delivery to the machine 14, or both.

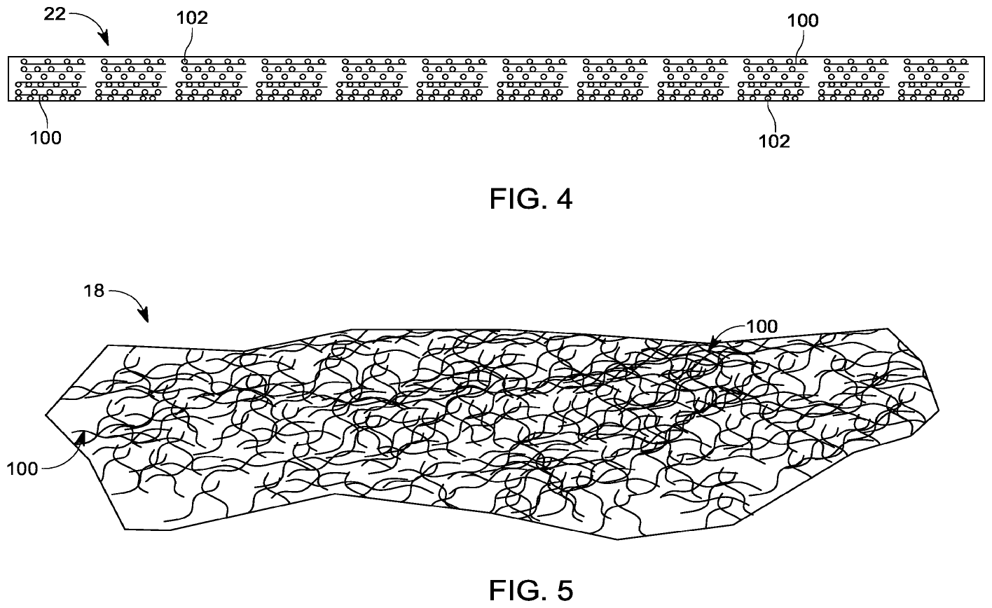

As shown in FIG. 4, the precursor material 22 appears as a combination of compacted fibers 100. There may be one or more additives 102 dispersed through the fibers 100. The one or more additives 102 may optionally include an expansion component arranged to cause expansion of the precursor material 22 while passing through the fiber aeration machine 28. The precursor material 22 comprising the compacted fibers 100 and any additives 102 may be in sheet or roll form for ease of transport and delivery into the fiber aeration machine 28. As shown in FIG. 5, the precursor-derived cellulose insulation 18 formed by the precursor material 22 passing through the fiber aeration machine 28 is porous. It has characteristics as described herein suitable to function as an effective substitute for existing insulation products.

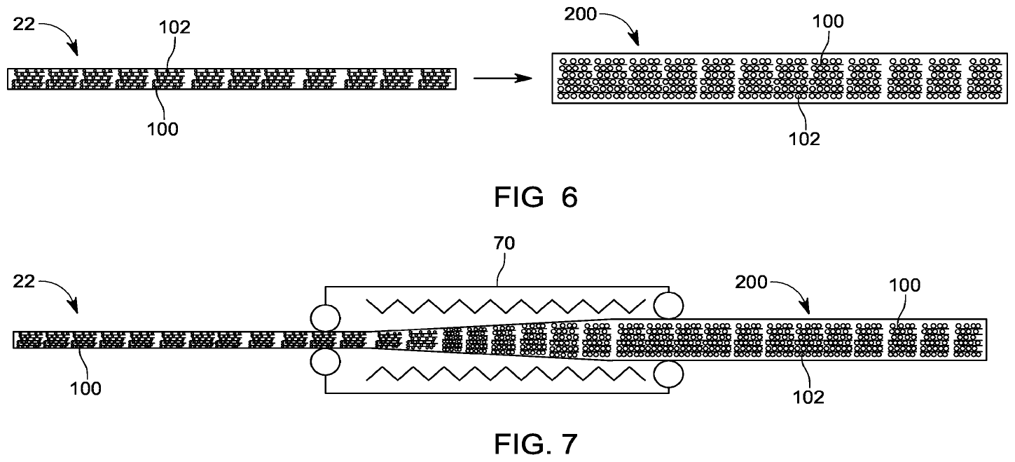

The fiber aeration machine 28 may include an expander component 70 arranged to cause the precursor material 22 in compressed form to expand. The optional expansion component may be a plurality of microbeads or foaming agent but not limited thereto. FIG. 6 represents an illustration of the appearance of the precursor material 22 before and after passing through the expander component 70, wherein the expansion component is activated to cause it to expand with sufficient force to reduce the density of the precursor material 22 and thereby form expanded precursor material 200.

An example of the expander component 70 is shown in FIG. 7. The example expander component 70 is a heater 70 over, through or under which the precursor material 22 passes, wherein the precursor material 22 includes a plurality of microbeads as an additive. The heater 70 is configured to generate enough heat imposed on the precursor material 22 to cause the microbeads to expand the volume of the precursor material 22, resulting in reduced density thereof. While the heater 70 is shown positioned prior to aeration, it is understood that it may be positioned after that section of the fiber aeration machine 28. The expander component 70 is generally configured to convert the precursor material 22 including an expansion component additive, such as a foaming agent or expandible beads, for example, into the expanded precursor material 200. The foaming agent may be reactive to heat or moisture, for example, to cause it to convert from a fluid form, such as a liquid, into a foam form. The foam formed may remain within the dimensions of the precursor material 22, or it may extend beyond those dimensions. The expandible beads may be expanded by the application of heat but not limited thereto. The expander component 70 may therefore be a heater, a foam activator, a moisture delivery component, or any combination thereof.

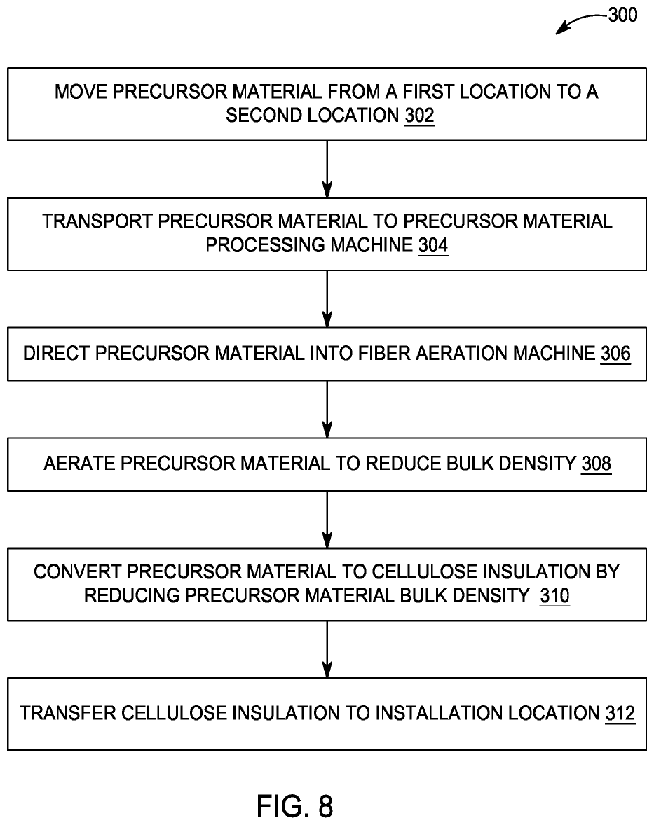

A method 300 of the present invention employing the apparatus 10 and the precursor material 22 of the present invention shown in FIG. 8 includes primary steps for converting the precursor material 22 into the insulation product 18. In a first step 302, the precursor material 22 produced at a first location is moved to a second location that may be spaced from the first location. For example, the first location may be a precursor manufacturing facility and the second location may be an insulation installation site. In a second step 304, the precursor material 22 is transported from the supply 12 at the second location by transport component 24 to the precursor processing machine 14. In a third step 306, the precursor material 22 is directed into the fiber aeration machine 28. In a fourth step 308, the precursor material 22 is aerated in the fiber aeration machine 28 to reduce the bulk density of the precursor material 22. In a fifth step 310, the aerated precursor material is converted into the insulation 18. In a sixth step 312, the insulation 18 is transferred with insulation material delivery component 36 to an installation location. Optionally, either or both of the precursor material 22 and the insulation 18 may be treated with one or more additives prior to transfer of the insulation to the installation location. Optionally, the precursor material 22 may be shredded before conversion to the insulation 18. Optionally, the precursor material 22 includes one or expansion elements and the method optionally includes the step of expanding the one or more expansion elements.

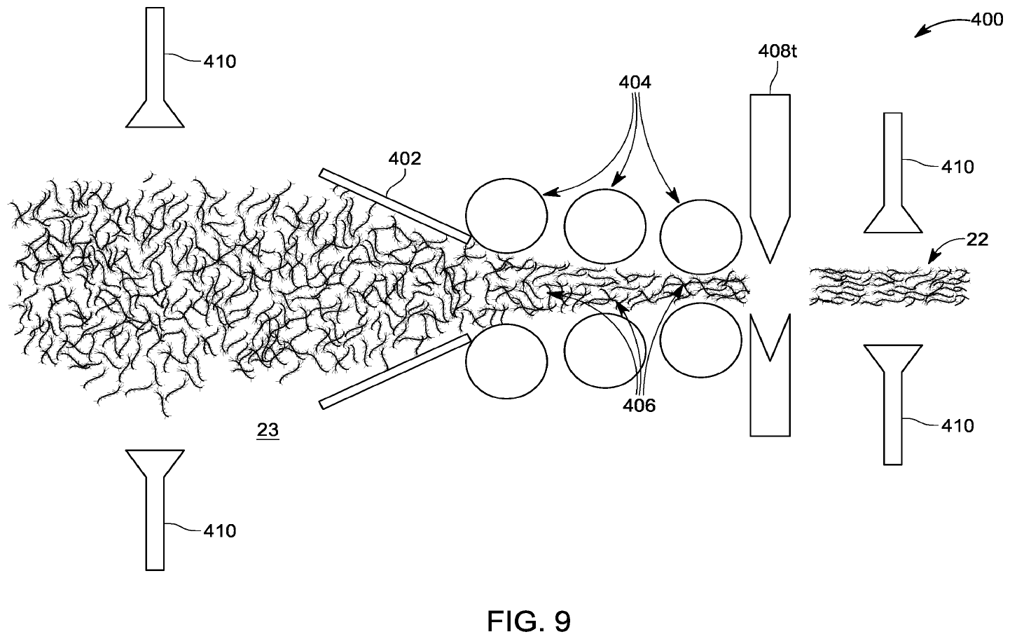

A first apparatus 400 for manufacturing the cellulose precursor material 22 is show in FIG. 9. Loose separated cellulose fibers 23 that may have been fibrillated, roughened, sized, separated, chopped or size sorted upstream by sieves, rotatory separation or air winnowing are fed though a pre-compression guide chute 402 and into a series of rotary compression rollers 404 including nips 406. The number of compression rollers 404 and nips 406 can range from a single paired nip to a multi-stage array including multiple paired rollers with decreasing nip width spacing. The rollers 404 can be Teflon treated or chrome plated and may be heated to activate additives or binders if necessary. While continuous rotary compression rollers 404 are demonstrated here, single, or multi-opening platen presses are equally useful for densifying the loose separated fibers 23 into one or more sheets of the cellulose precursor material 22. The rollers 404 are arranged to organize, align, and assemble the loose cellulose fibers 23 into a medium density mat, batt, sheet, board or web. That is, the loose fibers 23 are packed to an extent that makes the bulk density of the cellulose precursor material 22 greater than the bulk density of the loose fibers 23 prior to modification. The cellulose precursor material 22 is shown as a sheeted product with the incorporation of a guillotine cutter 408; however, similar sheeting devices to the guillotine cutter 408 commonly found in paper and rigid board sheet goods production can be used. In the absence of the guillotine cutter 408, the cellulose precursor material 22 can be self-wound in a roll or bail. Application of binders, fire retardants, colorants or other processing additives can be applied by spray nozzles, curtain coating, offset roll coating, gravure roll transfer coating 410 either to the loose uncompressed fibers 23, to the completed precursor material 22 or both.

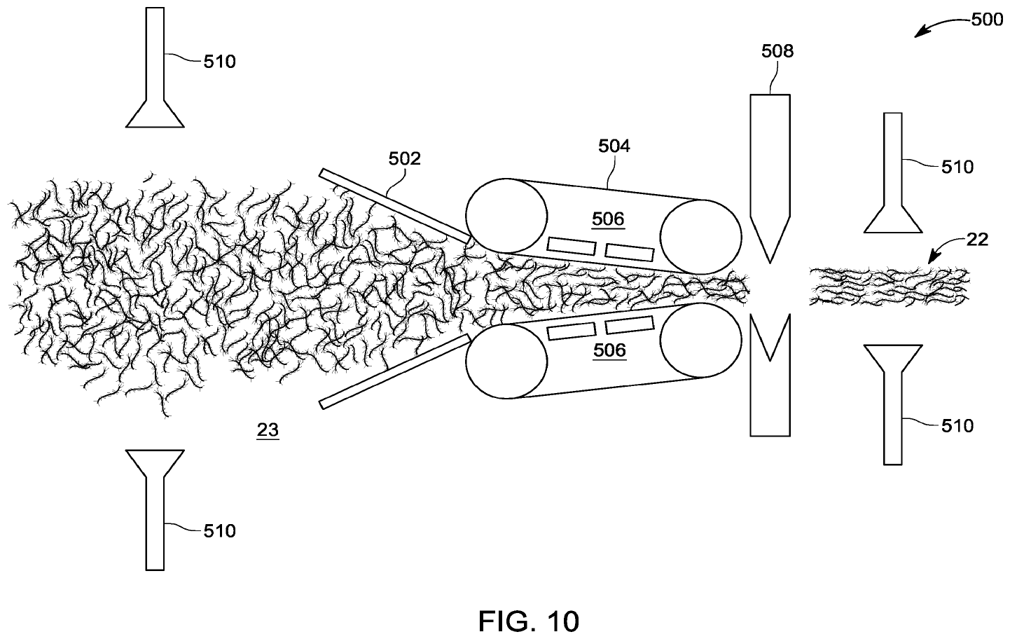

A second apparatus 500 for manufacturing the cellulose precursor material 22 is show in FIG. 10. The loose separated cellulose fibers 23 that may have been fibrillated, roughened, sized, separated, chopped or size sorted upstream by sieves, rotatory separation or air winnowing are fed though a pre-compression guide chute 502 and into a tapered nip compression belt 504. The belt 504 can be made from fiberglass reinforced rubber or silicone although the preferred construction of the belts 504 is chrome plated metal. The pressure exerted by the belt 504 on the loose fibers 23 can be moderated using multiple pressure zones 506. The compression belt 504 can be heated if needed. The belt 504 is arranged to organize, align, and assemble the loose cellulose fibers 23 into a medium density mat, batt, sheet, board or web. That is, the loose fibers 23 are packed to an extent that makes the bulk density of the cellulose precursor material 22 greater than the bulk density of the loose fibers 23 prior to modification. The cellulose precursor material 22 is shown as a sheeted product with the incorporation of a guillotine cutter 508, however similar sheeting devices to guillotine cutter 508 commonly found in paper and rigid board sheet goods production can be used. In the absence of the guillotine cutter 508, the cellulose precursor material 22 can be self-wound in a roll or bail. Application of binders, fire retarders, colorants or other processing additives can be applied by spray nozzles, curtain coating, offset roll coating, gravure roll transfer coating 510 either to the loose uncompressed fibers 23, to the completed precursor material 22 or both.

While the present invention has been described with respect to specific embodiments, it is not intended to those expressly described embodiment. Instead, the invention is described in the appended claims as well as all reasonable equivalents.

What is claimed is:

1. A cellulose precursor material for making cellulose insulation at an insulation installation location, wherein the cellulose insulation has a bulk density less than a bulk density of the cellulose precursor material, the cellulose precursor material comprising:
a plurality of fibers, wherein at least a portion of the plurality of fibers are cellulose fibers; and
a binder that joins at least a portion of the plurality of fibers together, wherein a binding strength of the binder is sufficient to keep the at least a portion of the plurality of fibers joined together while the precursor material is transported while allowing the at least a portion of the plurality of fibers to be separated from each other to form the cellulose insulation.

2. The cellulose precursor material of claim 1, wherein the cellulose precursor is in sheet form.

3. The cellulose precursor material of claim 2, wherein a plurality of sheets of the cellulose precursor material are stacked together.

4. The cellulose precursor material of claim 3, further comprising a separating interleave element to separate individual sheets of the stack.

5. The cellulose precursor material of claim 2, wherein the sheet has a slippery surface.

6. The cellulose precursor material of claim 1, further comprising a fire retardant added to at least a portion of the plurality of fibers.

7. The cellulose precursor material of claim 1, further comprising one or more expansion elements dispersed with at least a portion of the plurality of fibers.

8. The cellulose precursor material of claim 1, wherein at least a portion of the plurality of fibers are separated from one another without binding.

9. The cellulose precursor material of claim 1, wherein the binder is lightly adhering.

10. The cellulose precursor material of claim 1, wherein the binder disintegrates in the course of forming the cellulose insulation.

11. The cellulose precursor material of claim 1, wherein the at least a portion of the plurality of fibers are generated from paper.

12. The cellulose precursor material of claim 1, wherein the binder employs hydrogen bonding.

13. The cellulose precursor material of claim 1, wherein the binder forms covalent connections between individual ones of the plurality of fibers.

14. The cellulose precursor material of claim 1, where in the binder also acts as an expansion element

15. The cellulose precursor material of claim 1, wherein the precursor material is aerated and mixed with a conventional loose-blown cellulose insulation at a remote location to meet targeted performance characteristics of the cellulose insulation.

16. An apparatus for converting cellulose precursor material into cellulose insulation at an insulation installation location, the apparatus comprising:
a transport component coupled to a supply of the cellulose precursor material;
a precursor material processing machine coupled to the transport component and arranged to receive the cellulose precursor material from the transport component, wherein the precursor material processing machine includes a fiber aeration machine arranged to convert the cellulose precursor material into the cellulose insulation; and
an insulation installation component arranged to receive the cellulose insulation from the precursor material processing machine and deliver it to the insulation installation location.

17. The apparatus of claim 16, wherein the fiber aeration machine includes an aerator selected to fluff fibers of the cellulose precursor material.

18. The apparatus of claim 16, further comprising an additive supplier coupled to the precursor material processing machine and arranged to supply one or more additives to the precursor material and/or the insulation prior to delivery of the insulation to the insulation installation component.

19. The apparatus of claim 16, wherein the insulation installation component includes a blower arranged to draw the insulation from the precursor material processing machine and deliver it through a hose to the insulation installation location.

20. The apparatus of claim 16, further comprising an expander component arranged to expand expansible material located in the precursor material.

21. The apparatus of claim 20, wherein the expander component is a heater.

22. The apparatus of claim 16, wherein the cellulose precursor material is in the form of a sheet, and wherein the transport component is configured to transfer the cellulose precursor material to the precursor material processing machine in sheet form.

23. The apparatus of claim 16, wherein the cellulose precursor material is in the form of a sheet in a fanfold configuration, and wherein the transport component is configured to transfer the cellulose precursor material to the precursor material processing machine in fanfold configuration.

24. The apparatus of claim 16, further comprising one or more monitors for monitoring operation of one or more components of the apparatus.

25. The apparatus of claim 16, further comprising a controller coupled to one or more components of the apparatus for controlling operation of the one or more components.

26. The apparatus of claim 25, wherein the controller is a remote controller.

27. A method for converting cellulose precursor material into cellulose insulation at an insulation installation location, the method comprising the steps of:
moving the cellulose precursor material from a first location to the insulation installation location, wherein the first location and the insulation installation location are not the same;
transporting the cellulose precursor material to a precursor material processing machine;
directing the cellulose precursor material to a fiber aeration machine;
aerating the cellulose precursor material to reduce the bulk density of the cellulose precursor material and convert the cellulose precursor material into the cellulose insulation; and
transferring the cellulose insulation from the precursor material processing machine to the insulation installation location.

28. The method of claim 27, further comprising the step of treating either or both of the cellulose precursor material and the cellulose insulation with one or more additives prior to transfer of the insulation to the installation location.

29. The method of claim 27, wherein the cellulose precursor material is paper-based, the method further comprising the step of shredding the cellulose precursor material prior to aerating it.

30. The method of claim 27, wherein the cellulose precursor material includes one or more expansion elements, the method further comprising the step of expanding the one or more expansion elements.

31. The method of claim 30, wherein the step of expanding is accomplished by heating the expansion components.

31. A method for making a cellulose precursor material comprising the steps of:
directing a plurality of loose cellulose fibers having a first bulk density to an apparatus configured to convert the loose cellulose fibers into the cellulose precursor material; and
organizing, aligning, and assembling the loose cellulose fibers into a mat, batt, sheet, board, or web of the cellulose precursor material, wherein a bulk density of the cellulose precursor material is greater than a bulk density of the loose cellulose fibers.

32. The method of claim 31, further comprising the step of compressing the mat, batt, sheet, board, or web to a bulk density greater than 9 lbs./ft³.

33. The method of claim 32, wherein the step of compressing is completed by rollers, platens, or under vacuum assisted compression.

34. The method of claim 31, further comprising the steps of:
separating at least a portion of the fibers of the cellulose precursor material; and
reassembling the separated at least a portion of the fibers.

35. The method of claim 31, further comprising the step of size sorting the loose cellulose fibers prior to the step of organizing, aligning, and assembling.

36. The method of claim 31, wherein the step of organizing, aligning, and assembling includes the step of air-laying the loose fibers into the mat, batt, sheet, board, or web.

37. The method of claim 31, further comprising the step of applying a binder to the cellulose precursor material.

38. The method of claim 37, wherein the step of applying is carried out by spraying, dip-coating, curtain coating, or impregnating the binder on the mat, batt, sheet, board, or web.

39. The method of claim 31, further comprising the step of spraying, infusing, or saturating a binder into the loose cellulose fibers prior to the step of organizing, aligning, and assembling.

40. The method of claim 31, further comprising the step of vacuum packaging, fanfolding, or rolling the assembled cellulose precursor material.

41. An apparatus for making a cellulose precursor material from loose cellulose fibers, the apparatus comprising:
a pre-compression guide chute arranged to receive the loose cellulose fibers; and
a plurality of compression rollers arranged to receive the loose cellulose fibers from the pre-compression guide chute, wherein the plurality of compression rollers are arranged to organize, align, and assemble the loose cellulose fibers into the cellulose precursor material.

42. The apparatus of claim 41, further comprising a plurality of nips interactive with the plurality of compression rollers.

43. The apparatus of claim 41, further comprising means for fibrillating, roughening, sizing, separating, and/or chopping the loose cellulose fibers prior to delivery to the pre-compression guide.

44. The apparatus of claim 43, wherein the means is selected from one or more of sieves, rotatory separation, or air winnowing.

45. The apparatus of claim 41, wherein the rollers are Teflon treated or chrome plated and heated.

46. The apparatus of claim 41, further comprising a guillotine cutter to convert the cellulose precursor material into sheet form.

47. An apparatus for making a cellulose precursor material from loose cellulose fibers, the apparatus comprising:
a pre-compression guide chute arranged to receive the loose cellulose fibers; and
a tapered nip compression belt arranged to receive the loose cellulose fibers from the pre-compression guide chute, wherein the plurality of compression rollers are arranged to organize, align, and assemble the loose cellulose fibers into the cellulose precursor material.

48. The apparatus of claim 47, further comprising means for fibrillating, roughening, sizing, separating, and/or chopping the loose cellulose fibers prior to delivery to the pre-compression guide.

49. The apparatus of claim 47, wherein the means is selected from one or more of sieves, rotatory separation, or air winnowing.

50. The apparatus of claim 47, further comprising a guillotine cutter to convert the cellulose precursor material into sheet form.
